(19) United States
(12) Patent Application Publication
(10) Pub. No.: US 2007/0259302 A1
(43) Pub. Date: Nov. 8, 2007

(54) Adjustable and removable orthodontic device

(76) Inventor: Joseph Moin Jayawardena, Newburgh, NY (US)

Correspondence Address: JOSEPH M. JAYAWARDENA, 407, GIDNEY AVENUE, NEWBURGH, NY, 12550, US

(21) Appl. No.: 11/591,773

(22) Filed: Nov. 2, 2006

Related U.S. Application Data
(60) Provisional application No. 60/732,927, filed on Nov. 2, 2005.

(51) Int. Cl. A61C 7/14

(52) U.S. Cl. 433/10

(57) ABSTRACT

An orthodontic Bracket and tooth positioning system, consisting of a plurality of brackets, capable of moving the attached teeth in (all) 6 directions of (all) 3 planes to their desired final position. The basis of this movement is a unique two part construction of the brackets. The two parts are separated easily for readjustment in a different position. Many positions can be thus achieved with ease. The first part of the orthodontic bracket (Part A) consists of a mesh pad on its inner aspect to be bonded onto the surface of the enamel of the tooth; on the outer aspect it has 5 holes (indents). The second part (Part B) of the orthodontic bracket consists of a projection or peg to fit any of the holes on part A on its inner aspect, together with a slot on its outer aspect, for the arch wire to run through. Part B can be easily removed and realigned in a different hole to enable fine control to play on the arch wire. This easy removability allows for the introduction of different part Bs consisting of different slot shapes and sizes to further enhance control.

This application claims the benefit of U.S. Provisional 60/732,927 filed Nov. 2, 2005, which is herein incorporated by reference in its entirety.

### FIELD OF THE INVENTION

The present invention relates generally to Orthodontic bracket devices and more specifically, it relates to an Orthodontic bracket system, for providing control of fine and efficient movement of teeth.

### BACKGROUND OF THE INVENTION

Orthodontic braces have been in use for years. Orthodontic braces are utilized for correcting various types of malocclusions or misaligned teeth. Conventional braces are typically comprised of a plurality of brackets secured to the teeth, an arch wire that exists between the plurality of brackets, and elastic or metal ligature ties that are secured about the brackets for retaining the arch wire within each of the brackets. Additional force generating auxiliary devices, may be utilized in conjunction with the brackets and arch wire to achieve various types of desirable forces upon the teeth.

The arch wire is the main (horse shoe or arch shaped) wire that fits into each of the brackets or other attachments, on the outside of an individual's teeth. The arch wire provides most of the forces that move the patient's teeth. The arch wire also provides a track along which the teeth move. Elastic ligature ties are, basically small elastic rings that are utilized to attach the arch wire to the brackets on the teeth. They come in different sizes for different levels of attachment. The arch wires come in different materials i.e., stainless steel or the more flexible nickel titanium. They can be round or a stiffer square or rectangular shape. The greater the size the stiffer the wire for levels of control on the teeth.

The main problem with conventional Orthodontics is the “fixed position adopted by the bracket after it is bonded. This results in several problems.

If the bracket is even slightly misaligned during bonding there is an unfavorable change in the movement of the tooth which has to be addressed and corrected.

Even with the brackets situated in the correct position, a really malposed tooth could cause great difficulty in the insertion and removal of specific arch wires. This usually manifests as a breaking of the bond between the bracket and the tooth necessitating rebonding.

A discovery of minor malpositions towards the end of the treatment period can potentially lengthen treatment time.

This also translates into a lack of control in fine tuning the final positions of the teeth before debracketing.

In many instances once a choice of a bracket is made, the treating dentist frequently has to, make do with that given size of bracket; it makes for significantly less control at different phases of treatment. Sometimes the thinner arch wires used in the initial treatment can tend to have a lot of play, even when not needed. At other times the wire can be too tight. Another potential problem is that once a size of the bracket is chosen the choices in wires tend to be limited.

The currently used Orthodontic systems are constrained by fixed bracket positions and fixed sizes and shapes (diameter) of the slot.

The brackets are attachments bonded to the patient's teeth utilizing a resin based adhesive. The brackets transmit the forces that help the teeth conform to the shape of the arch wire.

They usually comprise of a flat plate having a plurality of wings extending outwardly from thereof, defining horizontal passage for receiving the arch wire.

Brackets usually have a mesh pad on its inner aspect for bonding it to the tooth enamel.

On its outer aspect, there is a horizontal channel for the continuous arch wire, referred to as the slot. The slots are of varying diameter to enable different diameters of arch wire to be introduced, for varying degrees of force. Once the bracket is affixed to the tooth they remain till the end of treatment. An attempt is always made to bond the bracket in the dead center of the tooth, to provide uniform force to the tooth. An off center bracket could involuntarily place undesirable forces during treatment.

Conventional devices are not suitable for providing fine control in all directions and planes, during different phases of treatment They also lack versatility.

In these respects, the Orthodontic bracket and tooth positioning system according to the present invention, substantially departs from the conventional concepts and designs of the prior art, and in doing so, provides an apparatus for achieving adjustable and removable fine control of the orthodontic movement of the teeth to their final desired position more efficiently.

Orthodontics using conventional brackets have some built in drawbacks. The alignment of teeth has to be left to the relatively slow arch wire deflection, compared to the proactive adjustments capable in this invention. Fine control with ease is readily available in 6 directions and 3 planes simultaneously. These faster more accurate corrections affect the accuracy and speed of the result significantly. This benefits the patient, and provides better time management for the practitioner.

A further objective of the present invention is to enable different shapes and sizes of slot attachments to be incorporated into treatment. The ability to bring different brackets into the treatment simultaneously greatly enhances the ability to have individual control over different segments in an arch, increasing versatility.

Traditionally the commonest, most successful way of achieving this is through a Fixed appliance The teeth are moved gradually over a period of many (12-36) months.

A fixed orthodontic ‘appliance’ consists of 3 components:
1. A metal band cemented round the 1^{st} molar teeth in each quadrant of the jaw to provide the anchorage to move the teeth ahead. A tube is attached to its outer surface to allow for a wire to be passed through it.
2. A plurality of brackets which is the functional component of the system. These metal parts are attached to the front (labial) surface of the tooth, by bonding the inner mesh to the enamel of the tooth. The functional portion of the bracket is a metal slot of fixed dimension (rectangular) bounded by metal projections referred to as wings.
3. A wire (of stainless steel or nickel titanium) is conformed to the shape of a perfect arch—horseshoe shaped (or preformed) this is attached to the bracket slots by means of rubber ‘o’ rings or metal ties round the wings surrounding the bracket slot.

The teeth gradually move to acquire the shape of the arch wire. The teeth either move bodily through the bone or by the crown tipping to achieve the final desirable orthodontic position.

Pretreatment evaluation determines how arch space is utilized. This includes creation of space in crowded situations, through selective extractions-commonly bicuspid teeth bilaterally.

Movements in the initial phase of treatment are effected by arch wires of thinner—more flexible dimensions, to allow easier attachment to the bracket. (A stiffer wire could pull the bracket off or not engage a slot) As the teeth gradually approximate their eventual positions stiffer arch wires can be introduced to the slots to provide torque control (root angulations) more of the larger arch wire fill the space of the slot. Various forms of auxiliaries such as different types of rubber bands, elastics, springs and coils etc. are utilized to help provide additional movement.

During the past century Orthodontic Brackets of varying prescriptions have been developed.

In early Orthodontics emphasis was placed on making adjustments or ‘bends ’ to the arch wires to facilitate additional fine movements or modifications to the teeth in 3 plane/6 directions.
1. Up/down or Incisso-Gingival
2. Clockwise/counter clockwise “tipping’ movements of the incissal edges/occlussal surfaces
3. Rotation of the teeth about a horizontal axis.

Bodily movements (through bone) can be achieved with auxiliaries like rubber or elastic bands.

When space is created as in an extraction site the crowns of adjacent teeth can be coaxed to ‘tip’ into the space.

Biological limits have been worked out, to move teeth safely without excessive harmful forces on the vital teeth and bone.

As bracket technology developed, less emphasis needed to be placed on the art of wire bending. Ideal positions in 3 planes were machined into the bracket prescription.

However control continues to be an issue.

Some features of Orthodontic treatment common to different systems would include the following.

The bracket usually assumes a fixed position on the tooth once bonded on, till the end of treatment. Removing brackets if improperly placed, or to exert different force is tedious.

As a result the slot size is usually the same. (The force that is exerted on the wire has only different options from the size and material of the wire).

The bracket design is uniform through the arch.

### SUMMARY OF THE INVENTION

One of the ongoing problems inherent in current Bracket systems present in Orthodontics, is that once a bracket is bonded to a tooth, its position (in relation to the system) stays constant. Deflections to the arch wires in terms of modifying forces have to be placed extraneously. The current invention allows modifications to the arch wire or adjustments because the bracket is not “fixed” It allow the bracket to be easily repositioned on the tooth to create a controlled change in force in 6 directions.

In view of the forgoing disadvantages inherent in the known types of orthodontic brackets present from the prior art, the current invention provides a new Orthodontic bracket system construction, wherein the same can be utilized, for providing a removable totally adjustable Orthodontic bracket with a fully adjustable slot.

The general purpose of the present invention, which will be described subsequently in greater detail, is to provide a new Orthodontic bracket system, that has all of the advantages of the orthodontic brackets mentioned heretofore and many important and unique new features that result in a new orthodontic system, which is not anticipated, rendered obvious, suggested or even implied by any prior art orthodontic brackets, either alone or any combinations thereof.

To attain this, the present invention generally consists a Base which is bonded to the tooth with a fine mesh on its inside holes in a specific arrangement exist on its outside.

A second part of the bracket can be attached to these different positions by means of a peg which affixes in the holes. On the outside of the second (removable) part of the bracket exists the slot for the arch wire which in this specific case is of adjustable width. A mechanism exists to tighten the 2 parts of the slot against the arch wire to allow for different sizes of the slot with different tensions by means of 3 O rings of increasing tension.

There has thus been outlined, rather broadly, the more important features of the invention in order that the detailed description thereof may be better understood, and in order that the present contribution to the art may be better appreciated. There are additional features of the invention that will be described hereafter, and that will form the subject matter of the claims appended hereto.

In this respect, before explaining at least one embodiment of the invention in detail, it is to be understood that the invention is not limited in its application to the details of construction and to the arrangements of the components set forth in the following descriptions or illustrated in the drawings. The invention is capable of other embodiments, and of being practiced and carried out in various ways. Also, it is to be understood that the phraseology and terminology of the description, should not be regarded as limiting.

A primary object of the present invention is to provide an orthodontic bracket system that will overcome the shortcomings of the prior art devices.

A second object is to create a orthodontic bracket system for providing a removable, totally adjustable orthodontic bracket.

For the purpose of illustration the bracket base has been made ovoid. The same concept can be carried out with a round or square shape. The same holds for the shape of the peg.

The variable width of the slot is due to the specific members making up the slot can be drawn towards each other, providing greater or lesser tension on the arch wire by means of the O rings of varying tensions. Though modifications to this idea will be brought forth the concept remains unique.

The material the brackets are manufactured with will also play a role on the shape, size and outcome of the design with regards to ease of manufacture. The material can be a metal alloy or a polymer.

A polymer bracket has the advantages of less costly manufacture. It can also be more comfortable and rounded. It will be smaller than most brackets and easier to keep clean. Color coding will make it easy to organize an armamentarium. It will also be more attractive to patients who have a choice of colors.

A big advantage of a removable system will be the easy introduction of specific slot shapes when needed i.e.: round or rectangular diameter, auxiliary slot s shaped like a tube. Multiple slots for 2 wires will also be available. These will be very useful in torque control during the finishing stage.

All these concepts are perfectly workable with the machined prescriptions of all regular orthodontic brackets. In other words all the advantages of a given system including machined in tip and torque can be achieved with the new invention.

Furthermore since multiple adjustments are capable simultaneously a whole new treatment system is available

Treatment time will be dramatically shortened with much more accurate control of final tooth positions.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however that the drawings are illustrative only, and that the invention is specifically geared to many modifications in size and shape without affecting its concepts. Changes may be made in the specific shapes and construction illustrated and described within the scope of the appended claims.

Some Possible Variations to the Brackets

1. Part A with a mounting jig at the bottom. This is a small piece if 2 mm plastic attached, to help center the part A accurately in the center of the tooth 2 mm from the incissal edge. This jig is disconnected easily after bonding. It is used in a few other systems.
2. Part B with no movable slot. This is for use by a practitioner satisfied to only use the part A related control. This is a unique way to modify an existing bracket system.
3. Part B, with or without tip and torque machined in With a given prescription, tip and torque could be available with no special adjustments, as in straight wire technique. If the practitioner is interested in making fine adjustments on their own the device can be obtained with no tip or torque preset. This would allow for more individual skill to be exercised.
4. Part B with non movable 0.025 rectangular slot.A 0.020 or 0.022 round diameter slotwill provides more binding of a round wire.
5. A rectangular extra slot or tube above the part B slot for a torquing auxiliary in addition to the arch wire at the end of treatment
6. Part A with the superior slot only present on the middle hole for ease and cost. The adjustment of tipping of the incissal edge will have to come after the other adjustments. It is limited to the middle position.
8. A rectangular slot angled backwards for extra torque during Finishing
   The present invention also contemplates the following embodiments:
1. An easily adjustable, removable, Orthodontic Bracket system comprising a plurality of Brackets, connected to bands around anchor molars.
2. The said brackets comprising a unique two part construction, which is a departure from the prior art due to the fact that one part is fixed to the labial surface of the tooth with a resin cement, while the other part can be removed.
3. The fixed member, referred to as part A comprises a fine mesh on its inner aspect allowing it to be bonded to each tooth.
4. The outer surface of part A has a plurality (5 in this example) of indents or receptacles in the form of a cross on the center of the outer aspect of part A.
5. These indents allow the 2^{nd} part of the two part bracket referred to as part B to be attached to its outer surface.
6. Part B is comprised of a peg or protrusion on its inner aspect to fit the indents of said part A.
7. The peg placed in any of the indents on the outer surface of part A thus changing the position of part B with relation to part A.
8. The indents described in part A also possessing 3 notches on its upper borders. The notches forming 22 degree angles with the vertical.
9. The peg described on part B having an extension on its upper surface that corresponds to the 22 degree notches on part A. Thus by twisting part B to the vertical permits 3 positions in relation to one another.
10. The peg described in relation to the inner aspect of part B can be placed in any of the 5 indents on the outer aspect of part A.
11. These different positions allow part B to be moved with relation to part A.
12. The projection or peg on part B can be easily removed and moved to different positions on part A. which make it a 2 part removable, adjustable bracket system.
13. The aforementioned ‘peg’ can also be angled 22 degrees to the vertical to make contact with the corresponding indent on the top of each hole on part A
14. The outer aspect of part B comprises a slot for the arch wire to fit in.
15. This ‘slot’ has 4 projections (or ‘Wings) bounding it.
16. This afore mentioned orthodontic bracket is capable of being constructed in either metal or plastic
17. The arch wire, that runs through all the bracket slots are held in place by rubber O rings.
18. The Slot on the bracket can be of singular construction—i.e. of uniform width.
19. A variation exists in a unique movable slot.
20. The width of the slot on the outer surface of part B is adjustable
21. This allows Arch wires of varying sizes to be introduced easily.
22. The Slot which is described as Adjustable has 2 parts which slide in to one another vertically altering the width of the slot.
23. The 2 parts of the movable slot are held together by rubber ‘O” rings.
24. By using different “0” ring sizes different tensions can be brought to play on the slot members.
25. The Cross section width of the slot can be varied.
26. The shape of the slot can be varied.
27. An Armamentarium of slots of different sizes and shapes are possible.
28. Different levels of torque can be utilized when using the different slot design shapes.
29. By using the 5 different positions of part B in relation to the fixed part A, forces on the arch wire can be varied.
30. The Center hole position on part A is a “Neutral” position. Forces on the arch wire are not being modified in any direction.
31. When the Peg on part B is placed in the 12 o'clock (or north) position on the indents of the outer surface of part A, it imparts a (downwards) Extrusive force on the tooth attached to the arch wire.
32. When the peg on part B is affixed in the lowest (south or 6'O Clock) indent on part A it imparts an intrusive or upwards force on the arch wire (and tooth).
33. When the peg on part B is affixed in the right (3 O clock or east) indent of part A, it imparts a rotatory force on the long axis of the tooth by deflection of the arch wire.
34. When the peg on part B is affixed to the left (9 O'clock or west) indent of part A, it imparts o rotatory force on the long axis of the tooth, by deflection of the arch Wire.
35. When the peg on part B is angled 22 degrees from the vertical into the corresponding angulations on part A it imparts a tipping force n the incissal edge of the tooth through deflection of the arch wire.
36. The tipping movement described above can be achieved in an opposite direction by using the 22 degree angled on the opposite side of part A.
37. By adjusting the removable part B on the different hole positions (and angles) on art A Fine adjustments can be made to the position of the tooth through forces transmitted to the deflecting arch wire.
38. These fine movements compatible with the different positions occur in 3 Planes and 6 directions.
39. Different positions, and thus different forces can be utilized in different portions of the arch wire connected to the brackets.
40. These fine adjustments to the positions of the teeth can be made simultaneously.
41. These adjustments can be made in all phases of treatment.
42. Thus greater fine control can be made available when utilizing these fine adjustments the bracket is capable of
43. Brackets of any prescription can be modified to this 2 part construction with its positional variations. The 2 part sliding width slot allows for easier removal and insertion of arch wires of varying size and stiffness.
44. This modified slot can be included or excluded from the design. The adjustable slot allows for greater torque variations on the arch wire.
45. Different levels of torque can be brought to play on different segments of the arch wire, by using “O” rings of different tensions.
46. Part B can have different shapes and sizes of width, both fixed and adjustable.
47. Since the B part of the 2 part bracket construction, is easily removable a whole armamentarium of different Brackets can be utilized throughout treatment bringing greater control.

There are many other variations that can be introduced seamlessly to this versatile system.

Dimensions Associated with the Bracket Design

The average central incisor is 11 mm long and approximately 8 mm wide.

The bracket will be centered in the middle of the tooth. The bottom edge of part A will be 2 mm from the incissal edge of the tooth.

The shape of part A (in either metal or resin) will be round or ovoid.

It will be approx 4 mm diameter. On its inner aspect is a 3 mm diameter mesh pad of fine metal. This is to enable bonding resin to be placed to affix the bracket to the tooth. The thickness of part A is to be around 1.5 mm or so.

On the outer surface of part A are 5 indents.

Part B has a peg on its inner surface and a slot for the arch wire on its outer surface.

The dimensions of the peg are 1 mm wide and thick. On the upper aspect of it, is found a 0.5 mm protrusion. This helps it to fit the corresponding 3 positions on the tops of the 5 holes. The B part is twisted to fit any of the 3 positions.

The dimensions of part B is 2 mm diameter and 1.5 mm thick, excluding 1 mm peg on middle of inner aspect.

The thickness of the slot, if the fixed modification is 0.025 and 020 or 0.022 round diameter

Many changes can, and will be made during manufacture and testing of prototypes. This includes different shapes and dimensions. It is clearly understood, however that the underlying concepts remain unchanged. The patent does include and entertain many variations.

### DESCRIPTION OF THE PREFERRED EMBODIMENT

Turning now, descriptively to the drawings, in which similar reference characters denote similar elements throughout the several views.

Various other objects, features and attendant advantages of the present invention, will become fully appreciated as the same becomes better understood when considered in conjunction with the accompanying drawings, in which like reference characters designate the same or similar parts throughout the several views, and wherein:

### BRIEF DESCRIPTION OF THE DRAWINGS

Drawing 1

FIG. 1 refers to the prior art. It is a schematic of a frontal view of an average bracket bonded to the tooth. It is a single piece construction. The slot is bounded by 4 fixed projections commonly referred to as bracket wings. They form the finite boundaries of the slot—hence of a fixed dimension—usually rectangular. A common slot size would be a 0.022 mm or 0.025 mm. An ‘O’ Ring round the wings secures the arch wire flat against the bracket, in the slot The bracket is bonded on to the enamel with a resin on the mesh of its inner surface.

FIG. 2 refers to the prior art. It is a schematic of a side view of a typical bracket. The bottom part of the bracket in this view would represent the mesh.

Drawing 2

FIG. 1 refers to an arch wire running through CF brackets affixed to 3 teeth, Part A which has the mesh on its inner surface bonds on to enamel the 5 holes positioned like a ‘cross’. The part b affixes into one of the holes by means of a “Peg” (not visible in this schematic) As can be seen the center tooth has the peg in the highest hole to help EXIRUDE the tooth downwards to the level of the other teeth which use the center hole in this case. The “O-ring that holds the arch wire in the slot is represented in yellow.

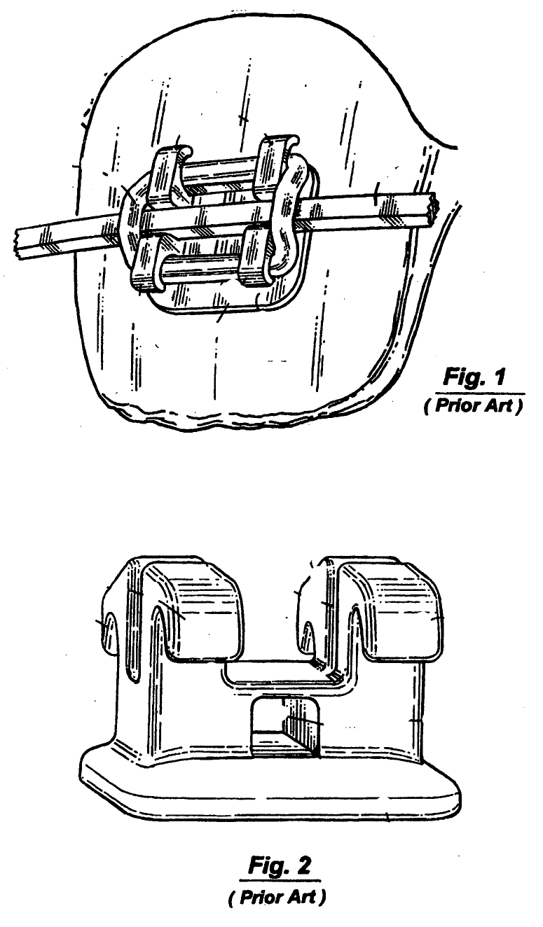

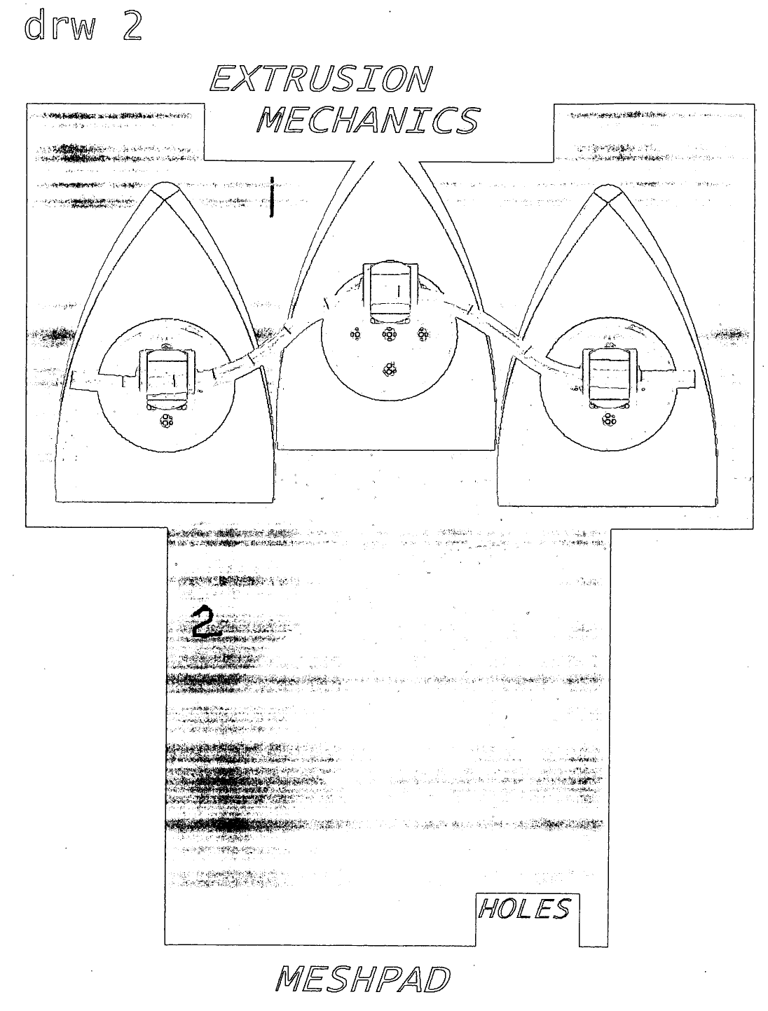

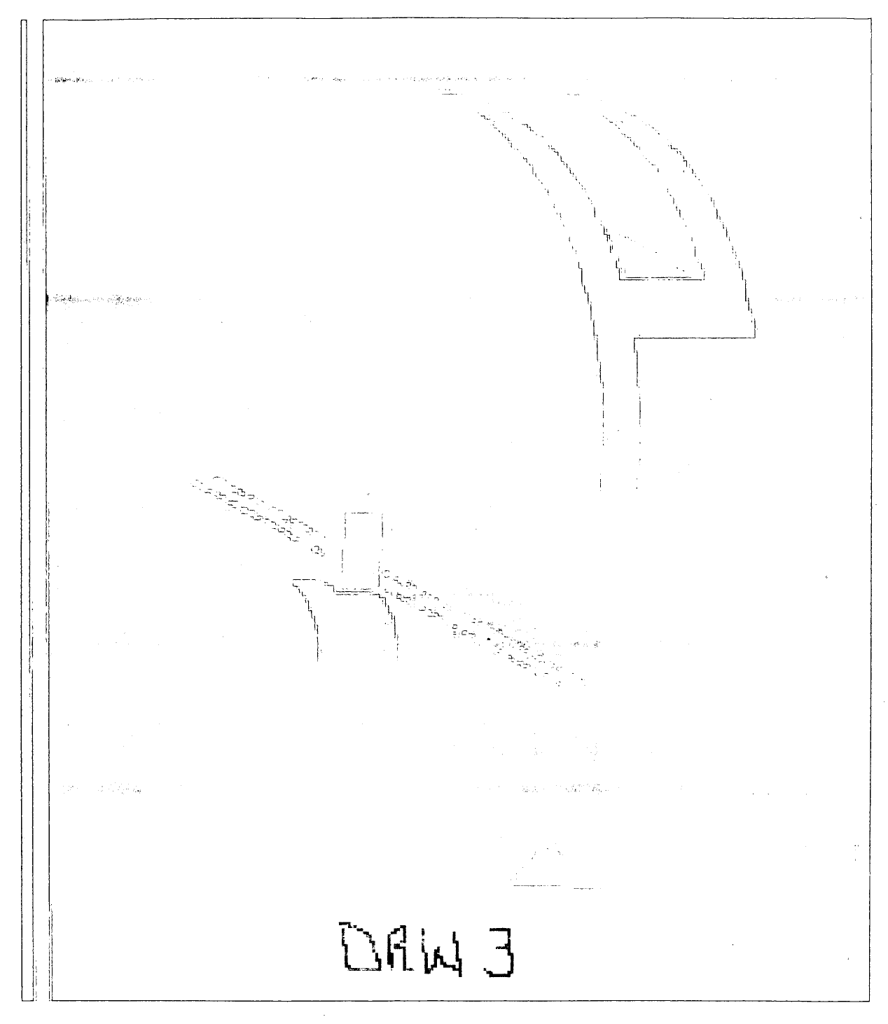

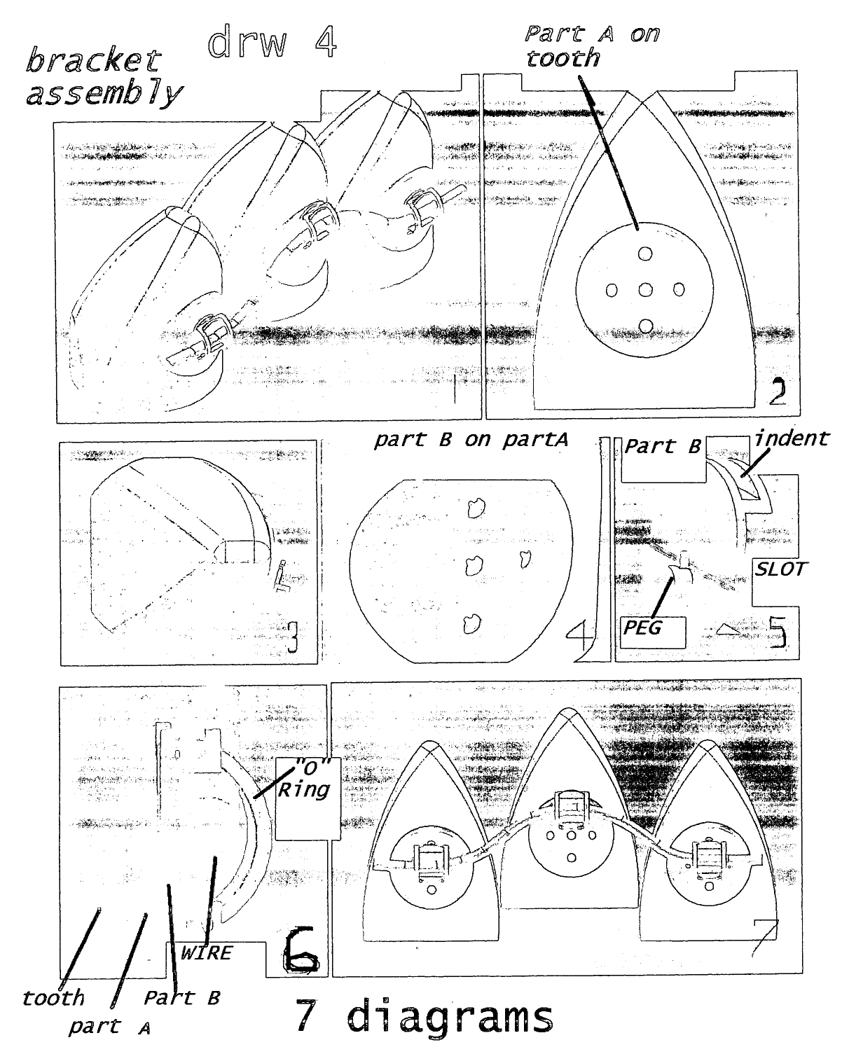

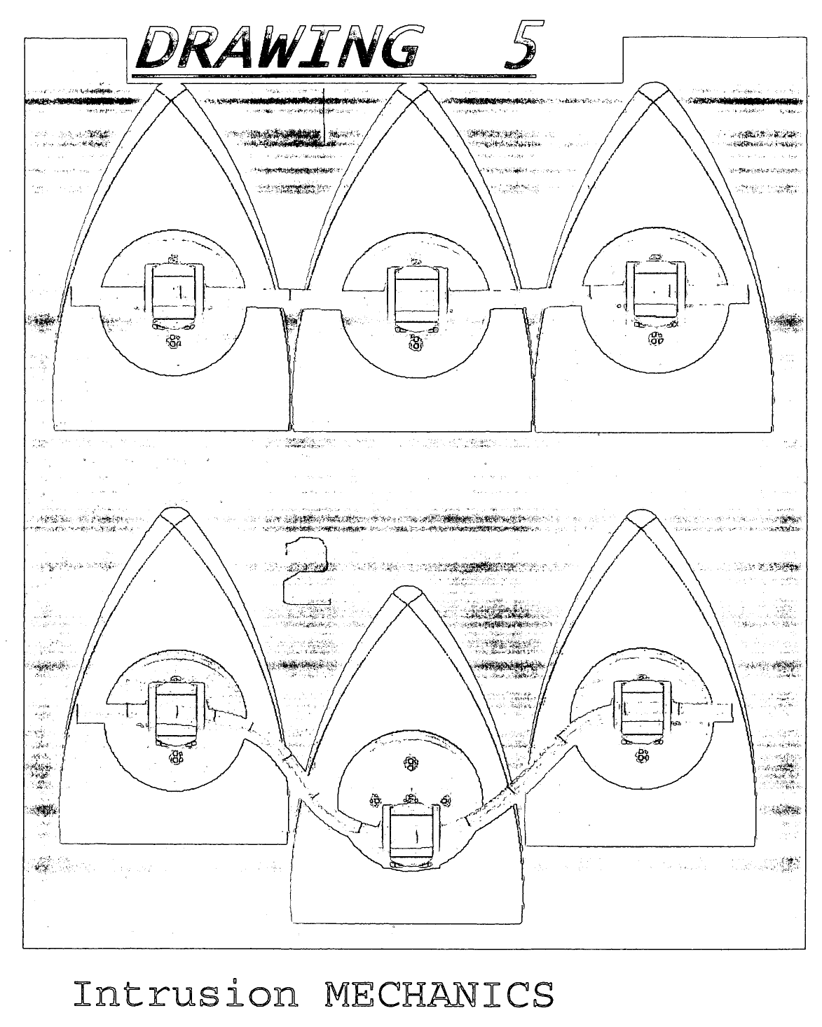

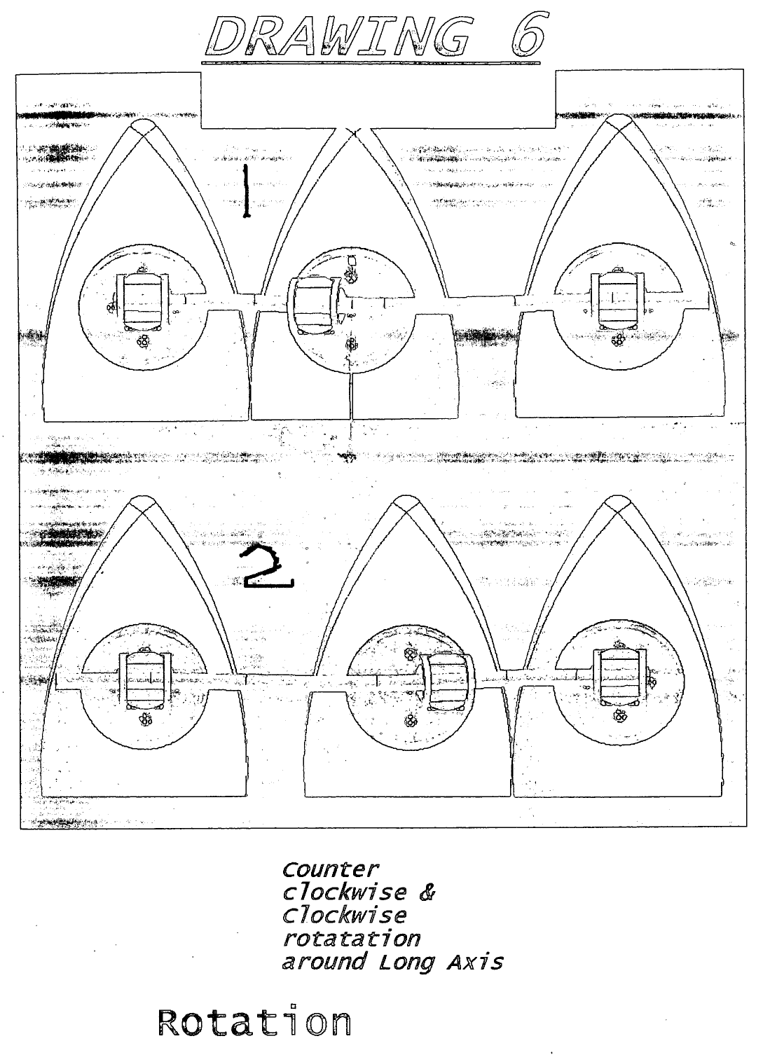

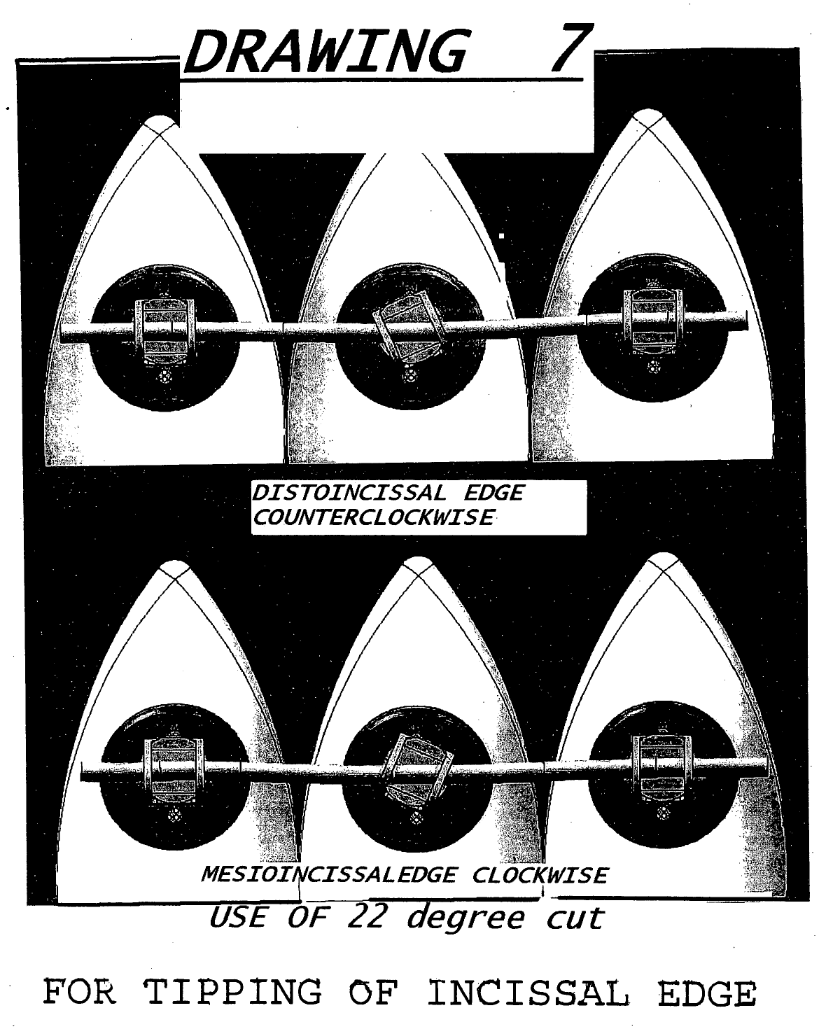

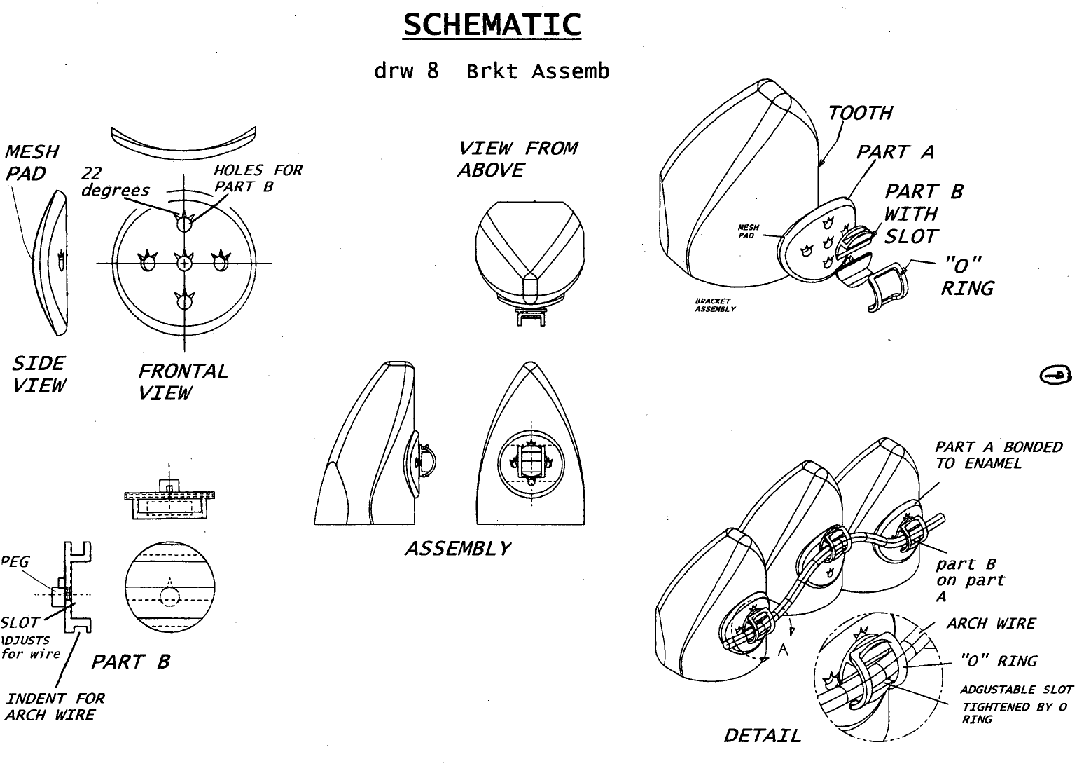

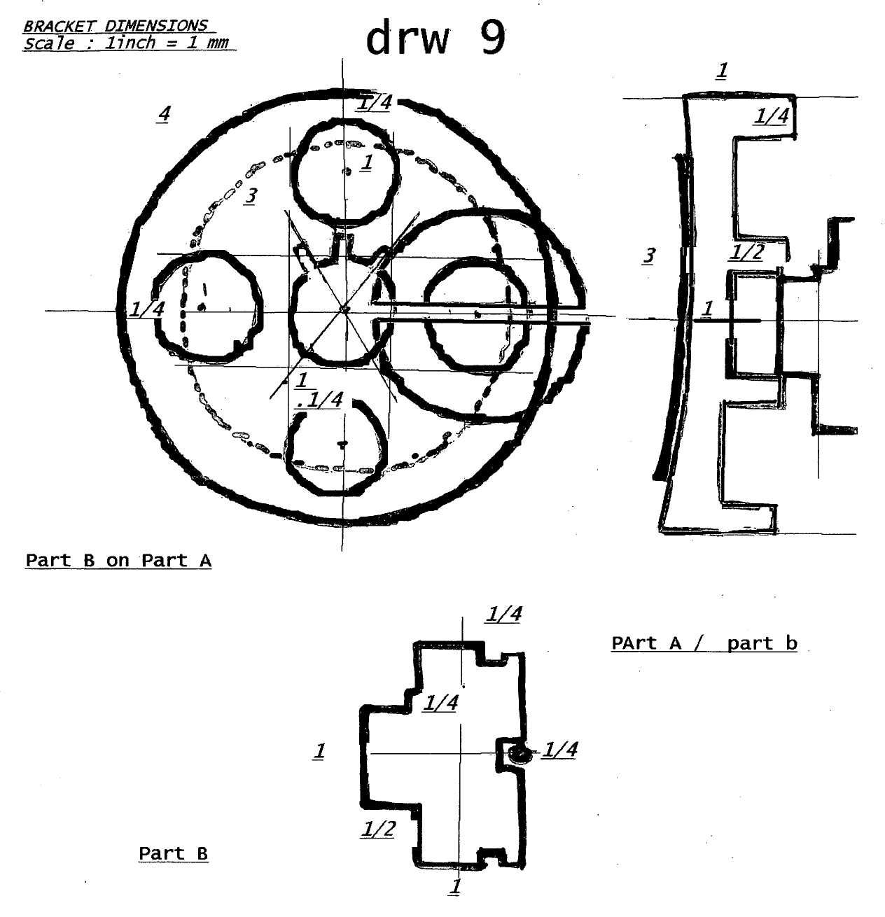

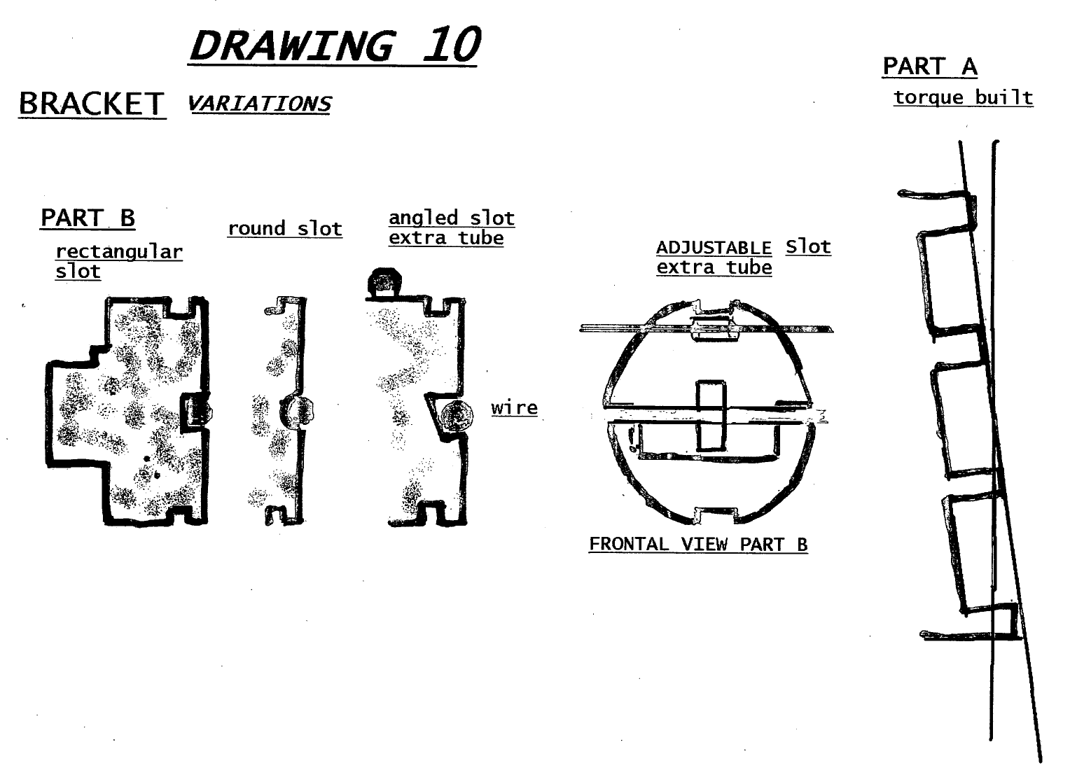

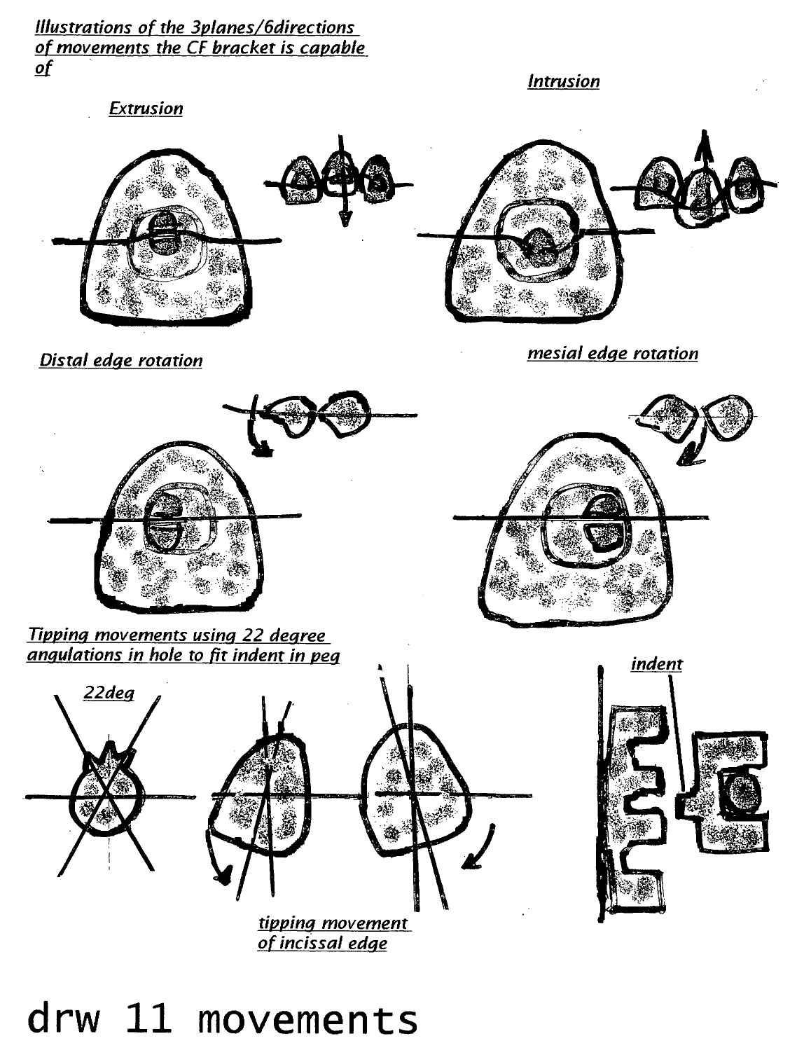

FIG. 2 is part A blown up to show the 5 holes set in a cross. Each hole has 3 cuts on its superior aspect angled at 22 degrees to allow the Peg in part B to be twisted on it for Tipping movements of the incissal edge.

(The inner aspect of part A has a fine wire mesh (as can be found on any bracket) to help bond the bracket to the enamel on the ‘front’ of the tooth with a bonding resin. It is not visible in this aspect.)

Drawing 3

This refers to Part B, which consists of a superior and inferior part that can be moved towards or away from each other with the intent of making the “slot smaller or larger. This is performed by means of “o” rings of different tensions that are placed around the indent. It also holds the arch wire in the slot at the same time. On its Inner surface the peg that fits into the holes of part A can be seen. On the top of the peg is a small projection that can fit the 22 degree indents on the upper surface of the holes on part A.3 such positions exist, at 22 degrees from each other. The center being vertical. The superior portion of part B slides into the lower (or inferior) portion. Held in place with the O ring. The different tensions allow for different widths of the slot. It also allows different levels of torque to be exerted on the arch wire. The shape of the slot can be modified to round, etc.

Drawing 4

This drawing consists of 7 figures.

FIG. 1 shows a 3 dimensional representation of 3 teeth connected by arch wire held in place by “0” rings (yellow) The center tooth is being EXTRUDED by means of a little extra controlled force. This is accomplished by moving the peg on part B to a higher hole on part A.

FIG. 2 is a frontal view of Part A affixed to tooth Enamel. This is done at the inception of treatment and is removed when debracketing at the end Again the Mesh on its inner aspect that helps to bond it is not visible in this projection.

FIG. 3 shows a hypothetical view from the side of a single tooth.

FIG. 4 is a diagrammatic representation of part B fixed to one of the holes in part A

FIG. 5 same as in drawing 3 showing part B

FIG. 6 A sideways hypothetical view of the arch wire, in cross section, being held in the slot, by the “0” Ring (yellow).

FIG. 7 same as in FIG. 1, with a frontal view (instead of 3 dimensional) of extrusion mechanics.

Drawing 5

FIGS. 1 and 2 (reversed) show intrusion Mechanics, with the extra controlled force, coming from attaching part B, to the lower hole on part A. If the position of the tooth is very malposed gentle force can be exerted at the start by using the center or even Upper hole as the case determines.

Drawing 6

FIGS. 1 & 2 represent diagrammatically the counter clockwise and Clockwise Rotation of the incissal edge of the tooth around its longitudinal axis. This is referred to as derotation. This mechanic is achieved by repositioning the peg in part b in one of the left and right (mesial and distal) hole positions. Many other specific variations are also possible in these positions.ie: by moving the B parts closer together, or away, teeth can be moved together or apart using auxiliary elastics. These positions allow more modification of the elastic forces.

Drawing 7

This drawing shows 2 figures of TIPPING movements. This is where the peg is rotated and placed in the 22 degree angulated indents of the hole imparting a twisting motion to tip on side of the incissal edge clockwise or counter clockwise.

Drawing 8

This is a Schematic that will help appreciate the bracket assembly better.

Is a side and frontal views of Part A along with a view from above The diagram on the upper right depicts the component s separated for a clear view.

The lower left shows the slot. The lower right is a detail of the attachment of the O ring to part B

Drawing 9

This drawing essentially shows the dimensions of the two parts of the Bracket in Millimeters. The scale is 1 inch=1 mm.

Drawing 10

This drawing shows the different variations possible.

The variations with part B illustrate the different slot shapes

Traditional 0.025 rectangular

Slot with 0.022 round diameter

Angled slot for more torque during finishing

Extra tube for more torque placed superiorly to string auxiliary wire through

Modification of Part A to reflect built in Torque

A complete set of brackets would include a kit with all the modifications.

Drawing 11

Illustration/Schematic

Showing the 3 Plane/6 directional movements the bracket is capable upon imparting on the tooth

Extrusion

Intrusion

Distal/mesial edge rotation

Tipping movements (involving 22 degree indent)

Not illustrated are drawings with the CF modifications on preexistent bracket systems.

Unique features of this bracket system include:

4 directions of fine control (in 2 planes) can be achieved, by placing the peg in the b) part into the appropriate one of the 5 ‘holes’ on part a). This permits intrusion and extrusion of the teeth in a vertical direction along with clockwise/counterclockwise rotation along the long axis of the tooth.

On the upper part of each ‘hole’ 3 positions of angulations of 22 degrees is possible by twisting the peg appropriately. This

allows for the ‘tipping’ motion of the incissal edge in a clockwise or counterclockwise rotatory plane

Since portion b) of the bracket with the peg can be quickly and easily removed and adjusted, an armamentarium of a number of different shaped and sized brackets could aid in making fine control easily possible regularly.

Slots can have round, square or rectangular cross sections.

They could be of different diameters ranging (0.014-0.025 mm CS)

The slots could be angulated gingivally to provide extra up righting forces to be applied on the roots.

A round diameter slot would fit a round diameter arch wire more snugly for more torque with a wire of smaller diameter, while a rectangular slot would permit more play. Easy control of these elements will be readily available as the particular situation warrants, due to easily removed armamentariums of brackets available in the system.

slot design could take on shapes such as a small tube to provide retention.

The adjustable nature of the slot dimension’ provides for easy insertion and removal of arch wires—especially in the presence of crowding and rotational malpositions’ common in many early phases of treatment.

The 3 different tensions imparted on the movable slot dimension by the 3 ‘o’ rings of different tensions allow for “differential torque control”. This could be used judiciously—simultaneous forces could result in unfavorable ‘vectors of force to affect teeth. A careful understanding of the fine control in so many planes can be used to counteract easy removability and the existence of so many variations to the brackets (and adjustable tensions) also result in usage of differential techniques when the need arises. Thus a new flexibility of treatment becomes available.

The adjustable slot is a concept. For ease of construction the 3 ‘O’ ring idea was conceived. The next generation can utilize a spring in the front of the slot to pull the 2 members together at different pressures negating the need for ‘O’ rings completely.

The design of a tube in place of a conventional slot means that arch wires can be ‘threaded’ (without the need for ‘o’ rings) through those slots—useful to keep an area (of the arch) stable as in a retentive phase.

A Polymer construction is sought for inexpensive manufacture allowing the luxury of a large armamentarium of bracket designs for greater options during treatment. Faster treatment times and greater degrees of fine control should follow. Treatment ease due to quick and easy wire changes also help. Polymers allow for different colored brackets, helpful in young patient acceptance, or esthetic concerns in older patients with tooth colored—less visible brackets Polymers are lightweight while retaining strength. More rounded less angular shapes can be adopted for reasons of comfort and ease of oral hygiene. Materials that ‘clean’ easily is another polymer advantage. Once manufacture is established polymer brackets are also easier and less expensive to turn out.

The most flexible attribute of this bracket system has to be its ease of adaptability to preexistent Bracket prescriptions.

A refreshingly fresh & flexible way of performing orthodontics could be available by adopting any level of the system. An entry level could consist of adopting its removability and fine control, to be adapted to any bracket system. A deeper understanding & usage of its full potential should generate a higher level of control—A higher goal of Orthodontics is treating separate segments of the arch simultaneously in a radical departure from conventional techniques, which result in slower changes to the treated dentition.

Manufacture of this device is similar to any of the brackets currently available on the market.

I claim:

1. An adjustable and removable orthodontic bracket assembly, capable of fine tooth movement in 3 planes and 6 directions comprising of a plurality of brackets attached to an arch wire which is in turn attached to the teeth to be moved, said brackets being of a two part construction comprising:
(a) a base member bonded to the labial surface of each tooth on its inner aspect and possessing a plurality of indented receptacles on its outer aspect; and
(b) a companion attachment comprising of a projection on its inner aspect capable of fitting the indented receptacles of (a), the outer aspect of which provides the arch wire contact surface,
wherein the companion attachment of (b) can be easily detached and adjusted in relation to the base member (of a) resulting in different forces applied to the wire and teeth.

2. The orthodontic bracket assembly of claim 1, wherein the arch wire contact surface is a movable two part construction which is capable of adjusting the width of the opening for the arch wire, wherein the said movable parts of the arch wire contact surface are held together at different tensions by means of O rings of varying sizes allowing the torque on the wire to be controlled.
